(19) United States
(12) Patent Application Publication
(10) Pub. No.: US 2012/0218220 A1
(43) Pub. Date: Aug. 30, 2012

(54) Switching and polling type capacitive touch method and wrist device applying the same

(75) Inventor: Kuo-Hsu Tsai, New Taipei City (TW)

(73) Assignee: Locosys Technology Inc., New Taipei City (TW)

(21) Appl. No.: 13/067,821

(22) Filed: Jun. 29, 2011

(30) Foreign Application Priority Data
Feb. 24, 2011 (TW) 100106121
Feb. 24, 2011 (TW) 100106125

(51) Int. Cl. G06F 3/044

(52) U.S. Cl. 345/174

(57) ABSTRACT

The present invention provides a wrist device comprising: a display screen; a transparent base layer provided above the display screen; a layer of transparent conductive thin film coated above or below the transparent base layer, the transparent conductive thin film layer being formed with plural sheet-like conductive thin film pads in a single layer; a flexible printed circuit board for connecting each of the plural sheet-like conductive thin film pads to a detecting circuit; and the detecting circuit for sensing a capacitance value of each of the plural sheet-like conductive thin film pads, and switching each of the plural sheet-like conductive thin film pads to be connected to ground. A switching and polling type capacitive touch method is also provided.

### BACKGROUND OF THE INVENTION

1. Field of the Invention

The present invention relates to a capacitive touch technology and its applications, and more particularly, to a switching and polling capacitive touch method and a wrist device applying such switching and polling capacitive touch method.

2. Description of the Related Art

At present, the development of a capacitive touch technology is relatively mature, and the capacitive touch technology has been applied in widespread to various industries. Commonly used touch panels, according to the induction principles thereof, are usually classified into four categories of resistive, capacitive, surface acoustic wave and optics touch panels. Current capacitive touch panels normally adopt a structure in form of the shapes such as a rhombus, a square, a circle, a comb, a spiral or the like. The capacitive touch schemes are generally divided into two types, one is referred to as surface capacitive touch scheme and the other is referred to as projected capacitive touch scheme.

However, a conventional capacitive touch panel usually adopts a two-layer structure, in which one layer is used as a ground layer and the other layer is patterned to form a desired design pattern such that a variation in the capacitance is produced (occurred) by a finger touch so as to achieve the goal for simulating the function of a button. With reference to FIG. 1, a commonly used design for a conventional sheet-like conductive thin film is shown. That is, FIG. 1 shows a two-layer structure including a layer with four sheet-like conductive thin film pads 11 to 14 and a reference “ground” layer 15 surrounding the four sheet-like conductive thin film pads 11 to 14. As a result, such a two-layer structure will lead to an increase in the fabricating cost of the conventional touch panel.

Further, with reference to FIG. 2, a schematic structural view of a touch panel for a conventional timepiece is shown. In FIG. 2, a reference numeral 22 indicates a transparent glass layer of a timepiece 21. In the outer circumference of the timepiece 21, a thin film of a flexible printed circuit board 23 is used as a conductive thin film for the purpose of capacitance detection. However, since the area of the thin film of a flexible printed circuit board 23 is limited, the sensitivity and stability for the capacitance detection is inferior.

### SUMMARY OF THE INVENTION

In view of the shortcomings of the conventional sensitive touch technology described in the above, an object of the present invention is to provide a switching and polling capacitive touch method and a wrist device applying the switching and polling capacitive touch method, which can remarkably enhance the stability and the sensitivity of the capacitance detection and decrease the manufacturing cost.

The present invention provides a switching and polling type capacitive touch method comprises the steps of: providing a transparent base layer; providing a layer of transparent conductive thin film above or below the transparent base layer by using a plating process, the transparent conductive thin film layer being formed in a single layer and with plural sheet-like conductive thin film pads; providing a flexible printed circuit board for connecting each of the plural sheet-like conductive thin film pads to a detecting circuit through a respective wiring; and providing the detecting circuit for sensing a capacitance value of each of the plural sheet-like conductive thin film pads, and switching each of the plural sheet-like conductive thin film pads to be connected to ground, wherein when the capacitance value of one of the plural sheet-like conductive thin film pads is to be sensed, the other ones of the plural sheet-like conductive thin film pads are switched to be connected to ground, and then in the same way, the capacitance value of each of the plural sheet-like conductive thin film pads can be obtained by sequentially polling each of the plural sheet-like conductive thin film pads.

There is provided a switching and polling type capacitive touch method in accordance with the present invention, wherein the capacitance value of one of the plural sheet-like conductive thin film pads is to be changed when a user's finger is approaching or touching one of the plural sheet-like conductive thin film pads, so that whether the user's finger is approaching or touching which one of the plural sheet-like conductive thin film pads can be realized through the detecting circuit.

There is provided a switching and polling type capacitive touch method in accordance with the present invention, wherein the material of the transparent base layer is a transparent glass or any other transparent materials.

There is provided a switching and polling type capacitive touch method in accordance with the present invention, wherein the plating process is an indium tin oxide (ITO) plating process.

The present invention provides a wrist device applying a switching and polling type capacitive touch method, comprising: a display screen; a transparent base layer provided above the display screen; a layer of transparent conductive thin film coated above or below the transparent base layer by using a plating process, the transparent conductive thin film layer being formed in a single layer and with plural sheet-like conductive thin film pads; a flexible printed circuit board for connecting each of the plural sheet-like conductive thin film pads to a detecting circuit through a respective wiring; and the detecting circuit for sensing a capacitance value of each of the plural sheet-like conductive thin film pads, and switching each of the plural sheet-like conductive thin film pads to be connected to ground, whereby when the capacitance value of one of the plural sheet-like conductive thin film pads is to be sensed, the other ones of the plural sheet-like conductive thin film pads are switched to be connected to ground, and then in the same way, the capacitance value of each of the plural sheet-like conductive thin film pads can be obtained by sequentially polling each of the plural sheet-like conductive thin film pads.

There is provided a wrist device in accordance with the present invention, wherein the capacitance value of one of the plural sheet-like conductive thin film pads is to be changed when a user's finger is approaching or touching one of the plural sheet-like conductive thin film pads, so that whether the user's finger is approaching or touching which one of the plural sheet-like conductive thin film pads can be realized through the detecting circuit.

There is provided a wrist device in accordance with the present invention, wherein the material of the transparent base layer is a transparent glass or any other kinds of transparent materials.

There is provided a wrist device in accordance with the present invention, wherein the plating process is an indium tin oxide (ITO) plating process.

There is provided a wrist device in accordance with the present invention, wherein the number of the sheet-like conductive thin film pads is 6 or 9.

### BRIEF DESCRIPTION OF THE DRAWINGS

The accompanying drawings, which are incorporated in and constitute a part of this specification, illustrate a preferred embodiment of the invention and, together with a general description of the invention given above, and the detailed description of the embodiment given below, serve to explain the principle of the invention, in which:

FIG. 1 shows a design for a conventional sheet-like conductive thin film;

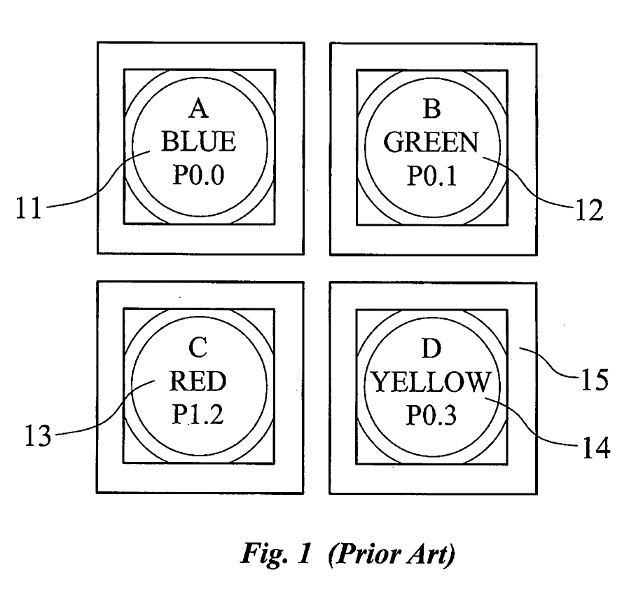

FIG. 2 is a schematic structural view of a touch panel for a conventional timepiece; and

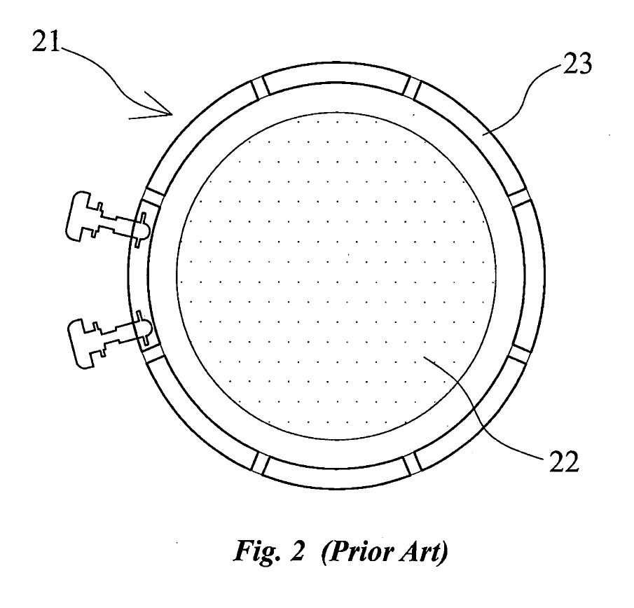

FIG. 3 is a schematic plan view of the wrist device in accordance with an embodiment of the present invention.

### DETAILED DESCRIPTION OF PREFERRED EMBODIMENTS

Embodiments in accordance with the present invention will be described hereinafter with reference to the accompanying drawings by exemplifying a switching and polling type capacitive touch method and a wrist device applying the switching and polling type capacitive touch method.

In the following, a switching and polling type capacitive touch method in accordance with an embodiment of the present invention is explained.

First, a transparent base layer is provided.

Next, a layer of transparent conductive thin film is provided above or below the transparent base layer by using a plating process. The transparent conductive thin film layer can be formed in a single layer and with plural sheet-like conductive thin film pads.

Then, a flexible printed circuit board is provided for connecting each of the plural sheet-like conductive thin film pads to a detecting circuit through a respective wiring.

After that, the detecting circuit is provided for sensing a capacitance value of each of the plural sheet-like conductive thin film pads, and switching each of the plural sheet-like conductive thin film pads to be connected to ground.

In the switching and polling type capacitive touch method, when the capacitance value of one of the plural sheet-like conductive thin film pads is to be sensed, the other ones of the plural sheet-like conductive thin film pads are switched to be connected to ground, and then in the same way, the capacitance value of each of the plural sheet-like conductive thin film pads can be obtained by sequentially polling each of the plural sheet-like conductive thin film pads.

Further, the capacitance value of one of the plural sheet-like conductive thin film pads is to be changed when a user's finger is approaching or touching one of the plural sheet-like conductive thin film pads, such that whether the user's finger is approaching or touching which one of the plural sheet-like conductive thin film pads can be realized through the detecting circuit.

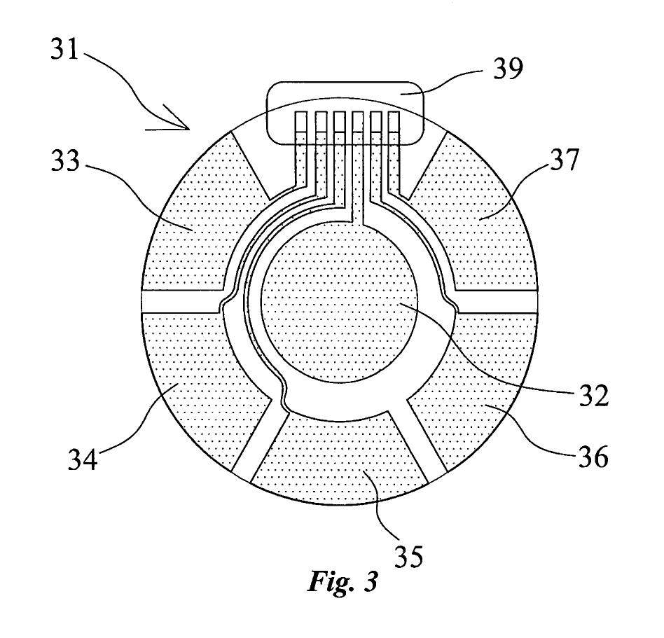

With reference to FIG. 3, a configuration of the wrist device 31 applying the switching and polling type capacitive touch method in accordance with an embodiment of the present invention is explained below.

FIG. 3 is a schematic plan view of the wrist device 31 applying the switching and polling type capacitive touch method in accordance with an embodiment of the present invention.

In FIG. 3, a transparent base layer (not shown) is provided above a display screen of the wrist device 31. As the transparent base layer, a transparent glass layer or any other kinds of transparent materials can be used. In this embodiment, the transparent glass layer is used.

Next, a single layer of transparent conductive thin film is coated on the transparent glass layer by using an indium tin oxide (ITO) plating process, for example. Such a conductive thin film can be formed with a plurality of sheet-like pads. In this embodiment, the conductive thin film is formed with 6 sheet-like conductive thin-film pads 32 to 37.

Then, by using a flexible printed circuit board 39, each of the sheet-like conductive thin-film pads 32 to 37 can be connected to a detecting circuit (not shown) through a respective wiring. The detecting circuit is used to sense a capacitance value of each of the sheet-like conductive thin-film pads 32 to 37, and switch each of the sheet-like conductive thin-film pads 32 to 37 to be connected to ground. When a user intends to sense the capacitance value of one of the sheet-like conductive thin-film pads, the other sheet-like conductive thin-film pads will be switched to be connected to ground. In this way, by sequentially polling each of the 6 sheet-like conductive thin-film pads, the capacitance value of each of the 6 sheet-like conductive thin-film pads can be obtained. Further, when the user's finger approaches or touches one of the 6 sheet-like conductive thin-film pads, the capacitance value of the one of the 6 sheet-like conductive thin-film pads will be changed. In this manner, whether the user's finger is approaching or touching which one of the 6 sheet-like conductive thin-film pads can be realized through the detecting circuit.

In another practical utilization, the sheet-like conductive thin-film pads can also be formed below the transparent glass layer. In this way, such a situation that the damage of the sheet-like conductive thin-film pads is caused by a direct contact of the user's finger to the sheet-like conductive thin-film pads can be prevented.

Therefore, in this embodiment, by merely requiring to use a single layer of conductive thin film in conjunction with the detecting circuit that can sense the capacitance values of the sheet-like conductive thin-film pads and/or switch the sheet-like conductive thin-film pads to be connected to ground as described in the above, such a movement that the user's finger is approaching or touching the sheet-like conductive thin-film pads on the wrist device can be accurately detected, and thus the wrist device in accordance with the embodiment of the present invention can be used a human/machine input interface. As shown in FIG. 3, the sheet-like conductive thin-film pads on the wrist device are used as 6 input buttons. Furthermore, if the conductive thin film is formed with 9 sheet-like conductive thin-film pads, i.e., in the form of a nine-square division, then the sheet-like conductive thin-film pads on the wrist device can be used as 9 input buttons. Needless to say, the rest can be deduced by analogy, namely, the conductive thin film of the wrist device can be formed with any number of sheet-like conductive thin-film pads.

By using the switching and polling type capacitive touch method described in the above, not only the movement that one finger of the user is approaching or touching one of the sheet-like conductive thin-film pads (i.e., the input buttons) can be detected, but also the action that plural fingers of the user are approaching or touching plural sheet-like conductive thin-film pads (i.e., the input buttons) can be detected.

In addition, in the sheet-like conductive thin-film pads that are entirely covered over the layer of transparent glass or other various kinds of transparent materials, due to a larger area, the range of variation of the sensed capacitance value will become larger when the user's finger approaches or touches the sheet-like conductive thin-film pads. Thus, the movement that the user's finger is approaching or touching the sheet-like conductive thin-film pads can be detected more stably and accurately.

Therefore, from the description in the above, the switching and polling type capacitive touch method and the wrist device 31 in accordance with the present invention can achieve the following merits.

(1) Since each of the plural sheet-like conductive thin film pads can be switched to be connected to ground through the detecting circuit, the electromagnetic interference (EMI) with respect to the sheet-like conductive thin film pad to be detected can be reduced, namely, the stability for the capacitance detection can be increased.

(2) When the capacitance values of the plural sheet-like conductive thin film pads are not required to be sensed, all of the plural sheet-like conductive thin film pads can be connected to ground so as to enhance the electrostatic discharge (ESD) protection.

(3) Since no additional grounding is required, the entire area of the transparent glass or other various kinds of transparent materials can be used for a detecting thin film, and thus the area of the detecting thin film is increased. That is, the sensitivity for the capacitance detection can be enhanced.

(4) Because no additional grounding is required, the total number of the wirings connected to the flexible printed circuit board can be reduced. That is, the width of the flexible printed circuit board can be further reduced, and thus the manufacturing cost thereof can be decreased.

(5) The human/machine input interface of a conventional wrist device is usually in a physical form of mechanical buttons, for example, the buttons of an electronic watch. Since the buttons are often provided on lateral sides of the watch, they are always interfered with the movements of the wrist joint of a user wearing the watch, which causes the user feeling uncomfortable. However, such a problem will not occur when the wrist device in accordance with the present invention is used.

In consequence, as compared with the conventional capacitive touch technology, the present invention provides a novel switching and polling capacitive touch method and a wrist device applying such switching and polling capacitive touch method, which can remarkably enhance the stability and the sensitivity of the capacitance detection and decrease the manufacturing cost.

While the present invention has been described in detail and pictorially in the accompanying drawings, it is not limited to such details since many changes and modifications recognizable to those skilled in the art can be made to the invention without departing from the spirit and the scope thereof.

What is claimed is :

1. A wrist device applying a switching and polling type capacitive touch method, comprising:
a display screen;
a transparent base layer provided above the display screen;
a layer of transparent conductive thin film coated above or below the transparent base layer by using a plating process, the transparent conductive thin film layer being formed in a single layer and with plural sheet-like conductive thin film pads;
a flexible printed circuit board for connecting each of the plural sheet-like conductive thin film pads to a detecting circuit through a respective wiring; and
the detecting circuit for sensing a capacitance value of each of the plural sheet-like conductive thin film pads, and switching each of the plural sheet-like conductive thin film pads to be connected to ground,
whereby when the capacitance value of one of the plural sheet-like conductive thin film pads is to be sensed, the other ones of the plural sheet-like conductive thin film pads are switched to be connected to ground, and then in the same way, the capacitance value of each of the plural sheet-like conductive thin film pads can be obtained by sequentially polling each of the plural sheet-like conductive thin film pads.

2. The wrist device as claimed in claim 1, wherein the capacitance value of one of the plural sheet-like conductive thin film pads is to be changed when a user's finger is approaching or touching one of the plural sheet-like conductive thin film pads, so that whether the user's finger is approaching or touching which one of the plural sheet-like conductive thin film pads can be realized through the detecting circuit.

3. The wrist device as claimed in claim 1, wherein the material of the transparent base layer is a transparent glass or any other transparent materials.

4. The wrist device as claimed in claim 1, wherein the plating process is an indium tin oxide (ITO) plating process.

5. The wrist device as claimed in claim 1, wherein the number of the sheet-like conductive thin film pads is 6.

6. The wrist device as claimed in claim 1, wherein the number of the sheet-like conductive thin film pads is 9.

7. A switching and polling type capacitive touch method comprises the steps of:
providing a transparent base layer;
providing a layer of transparent conductive thin film above or below the transparent base layer by using a plating process, the transparent conductive thin film layer being formed in a single layer and with plural sheet-like conductive thin film pads;
providing a flexible printed circuit board for connecting each of the plural sheet-like conductive thin film pads to a detecting circuit through a respective wiring; and
providing the detecting circuit for sensing a capacitance value of each of the plural sheet-like conductive thin film pads, and switching each of the plural sheet-like conductive thin film pads to be connected to ground,
wherein when the capacitance value of one of the plural sheet-like conductive thin film pads is to be sensed, the other ones of the plural sheet-like conductive thin film pads are switched to be connected to ground, and then in the same way, the capacitance value of each of the plural sheet-like conductive thin film pads can be obtained by sequentially polling each of the plural sheet-like conductive thin film pads.

8. The switching and polling type capacitive touch method as claimed in claim 7, wherein the capacitance value of one of the plural sheet-like conductive thin film pads is to be changed when a user's finger is approaching or touching one of the plural sheet-like conductive thin film pads, so that whether the user's finger is approaching or touching which one of the plural sheet-like conductive thin film pads can be realized through the detecting circuit.

9. The switching and polling type capacitive touch method as claimed in claim 7, wherein the material of the transparent base layer is a transparent glass or any other transparent materials.

10. The switching and polling type capacitive touch method as claimed in claim 7, wherein the plating process is an indium tin oxide (ITO) plating process.
